(19) United States
(12) Patent Application Publication
(10) Pub. No.: US 2011/0102174 A1
(43) Pub. Date: May 5, 2011

(54) APPARATUS AND METHOD FOR REMOTELY MONITORING AND COMMUNICATING WITH A USER

(76) Inventors: Ronald G. Pace, Naperville, IL (US); David Medeiros, Plainville, MA (US); Cynthia Fine, Sharon, MA (US); Robert Day, Brighton, MA (US); Mike Yoshiaki Daikubara, Quincy, MA (US)

(21) Appl. No.: 12/880,950

(22) Filed: Sep. 13, 2010

Related U.S. Application Data
(60) Provisional application No. 61/241,786, filed on Sep. 11, 2009.

(51) Int. Cl. G08B 1/08

(52) U.S. Cl. 340/539.15

(57) ABSTRACT

A baby monitor including a receiver configured to receive a plurality of digital signals, each produced by a separate electrical unit and representing an audible acoustical signal. The baby monitor also including a speaker configured to output the sounds represented by the plurality of digital signals, a microphone configured to detect sound waves generated by a first user, a CODEC configured to convert the sound waves generated by the first user to a digital signal, and a transmitter. The transmitter operable in a first mode, in which the transmitter transmits the digital signal representative of the sound waves generated by the first user to less than all of the electrical units from which it has received digital signals.

### CROSS-REFERENCE TO RELATED APPLICATION

This application claims the benefit of and priority to U.S. Provisional Patent Application No. 61/241,786 filed Sep. 11, 2009, the entire contents of which are hereby incorporated by reference.

### BACKGROUND OF THE INVENTION

Baby monitors use wireless communication technology to monitor a baby in a remote area (i.e., a location away from a parent, guardian, babysitter, etc.). A baby monitor provides parents the freedom to move about the house while still being able to hear their baby.

### SUMMARY OF THE INVENTION

Baby monitors typically include a parent unit (e.g., a receiver) and a baby unit (e.g., a transmitter) that monitor sounds generated by the baby. Some baby monitors also utilize video of the baby. The baby unit is positioned in the location where the baby is to be monitored while the parent unit is positioned in the location where the parent is and/or is worn or carried by the parent. The parent unit and the baby unit are capable of wirelessly communicating with each other via radio frequency signals. The baby unit has the capability of receiving acoustical audio signals generated by the baby, converting the acoustical audio signals to a radio frequency (RF) signal(s), and transmitting the RF signals to the parent unit. The parent unit has the capability of receiving the RF signals from the baby unit, processing and converting the RF signals to an acoustical audio signal, and outputting the acoustical audio signal to the parent.

In some embodiments of the present invention, the baby monitor described herein can include one or more baby units and one or more parent units. There is no particular limit as to the number of baby units and parent units that can be used in a household or in any one system. The baby monitor is configured for two-way communications and three-way communications between the various units. The communications between the various units can include audio only, audio and video, or video only. Vibration as a form of communication also can be utilized in any one or more of the units. The baby monitor also can include coded encryption for security purposes and to allow for voice privacy. Accordingly, one or more of the parent units and baby units can include appropriate encryption and decryption circuitry.

In some embodiments, the present invention provides a baby monitor comprising a receiver configured to receive a plurality of digital signals, each produced by a separate electrical unit, a speaker configured to output sound waves represented by the plurality of digital signals, a microphone configured to detect sound waves generated by a first user, a CODEC configured to convert the sound waves generated by the first user to a digital signal; and a transmitter. The transmitter is operable in a first mode, in which the transmitter transmits the digital signal representative of the sound waves generated by the first user to at least one of the electrical units from which the receiver has received a digital signal, and is operable in a second mode, in which the transmitter transmits the digital signal representative of the sound waves generated by the first user to a different one of the electrical units from which the receiver has received a digital signal.

In other embodiments, the present invention provides a baby monitor a baby monitor comprising a receiver, a speaker, a microphone, a CODEC, and a transmitter. The receiver is configured to receive a first digital signal produced by a first unit representative of sound waves generated by a first user, and a second digital signal produced by a second unit representative of sound waves generated by a second user. The speaker is configured to output the sounds generated by the first user during the output of the sounds generated by the second user. The microphone is configured to detect sound waves generated by a third user. The CODEC is configured to convert the sound waves generated by the third user to a digital signal. The transmitter is operable in a first mode, in which the transmitter transmits the digital signal representative of the sound waves generated by the third user to one of the first unit and the second unit, and operable in a second mode, in which the transmitter transmits the digital signal representative of the sound waves generated by the third user to both the first unit and the second unit.

In yet other embodiments, the present invention provides a baby monitor comprising a first unit, a second unit, and a third unit. The first unit includes a microphone configured to detect sound waves generated by first user, a CODEC configured to convert the sound waves to a digital signal, and a transmitter configured to transmit the digital signal representative of the sound waves generated by the first user. The second unit includes a receiver configured to receive the digital signal representative of the sound waves generated by the first user, a speaker configured to output the sounds generated by the first user as represented in the digital signal, a microphone configured to detect sound waves generated by a second user, a CODEC configured to convert the sound waves generated by the first adult to a digital signal, and a transmitter configured to transmit the digital signal representative of the sound waves generated by the second user. The third unit includes a receiver configured to receive the digital signal representative of the sound waves generated by the first user, a speaker configured to output the sounds generated by the first user as represented in the digital signal, a microphone configured to detect sound waves generated by a third user, a CODEC configured to convert the sound waves generated by the third user to a digital signal, and a transmitter configured to transmit the digital signal representative of the sound waves generated by the third user. Where the receiver of the second unit is further configured to receive the digital signal representative of the sound waves generated by the third user and the speaker of the second unit is further configured to output the sounds generated by the third user as represented in the digital signal, and where the receiver of the third unit is further configured to receive the digital signal representative of the sound waves generated by the second user and the speaker of the third unit is further configured to output the sounds generated by the second user as represented in the digital signal, such that the second unit outputs the sounds generated by the first user during the output of the sounds generated by the third user.

Other aspects of the invention will become apparent by consideration of the detailed description and accompanying drawings.

### BRIEF DESCRIPTION OF THE DRAWINGS

FIG. 1 illustrates a plurality of views of a parent unit according to one embodiment of the present invention.

FIG. 2 illustrates a plurality of views of a child unit according to one embodiment of the present invention.

FIG. 3 illustrates a plurality of views of a parent unit according to one embodiment of the present invention.

FIG. 4 illustrates a plurality of views of a child unit according to one embodiment of the present invention.

FIG. 5 illustrates a plurality of views of a parent unit according to one embodiment of the present invention.

FIGS. 6A and 6B are a schematic diagram of a power supply module of the parent unit illustrated in FIGS. 1, 3, and 5.

FIGS. 7A and 7B are a schematic diagram of a communications module of the parent unit illustrated in FIGS. 1, 3, and 5.

FIG. 8 is a schematic diagram of an audio CODEC module of the parent unit illustrated in FIGS. 1, 3, and 5.

FIGS. 9A and 9B are a schematic diagram of a power supply module of the child unit illustrated in FIGS. 2 and 4.

FIGS. 10A and 10B are a schematic diagram of a communications module of the child unit illustrated in FIGS. 2 and 4.

FIG. 11 is a schematic diagram of an audio CODEC module of the child unit illustrated in FIGS. 2 and 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Although directional references, such as upper, lower, downward, upward, rearward, bottom, front, rear, etc., may be made herein in describing the drawings, these references are made relative to the drawings (as normally viewed) for convenience. These directions are not intended to be taken literally or limit the present invention in any form. In addition, terms such as “first,” “second,” and “third” are used herein for purposes of description and are not intended to indicate or imply relative importance or significance.

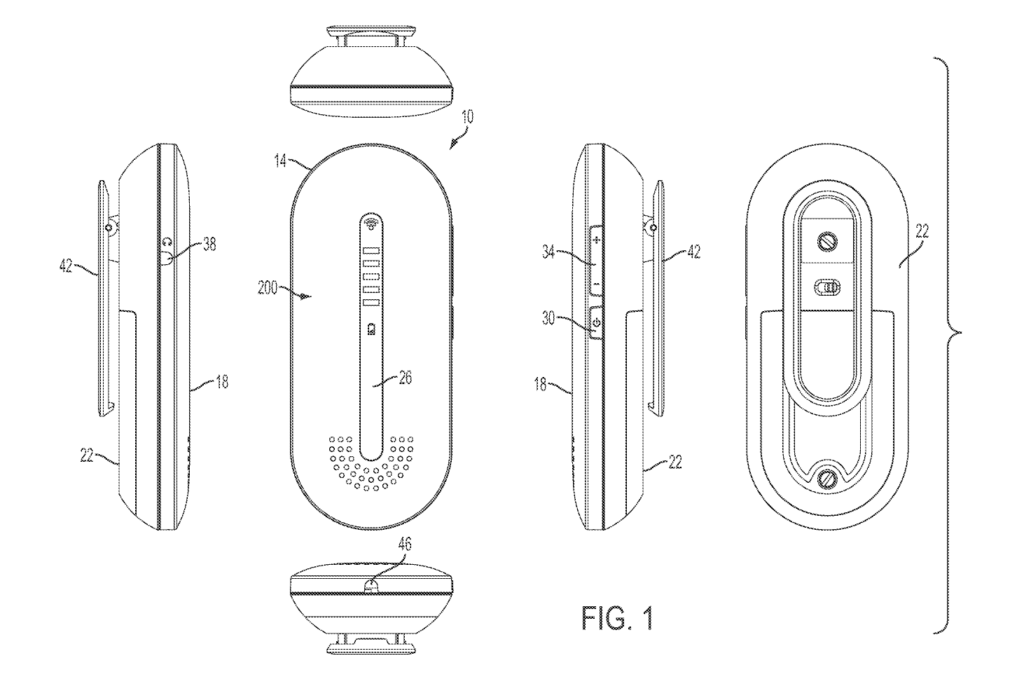

FIG. 1 illustrates a parent unit 10 according to one embodiment of the present invention. The parent unit 10 includes a housing 14 for supporting an electronics module (discussed below), a front panel 18, and a rear panel 22. The front panel 18 includes a user interface panel 26 having a plurality of indicators for a volume setting, battery life, and power. The user interface panel 26 can include other suitable indicators than the specific indicators illustrated. The user interface panel 26 also can include a screen for displaying video. The parent unit 10 also includes a power activation button 30 coupled to the housing 14 and a volume setting activation button 34 coupled to the housing 14. The parent unit 10 also can include a port 38 in which to connect a head set. The parent unit 10 also can include a clip 42 coupled to the rear panel 22 that the parent can use to clip the unit to a belt or to another location and carry the unit while working or moving. The parent unit 10 also can include a port 46 to connect to an external power source.

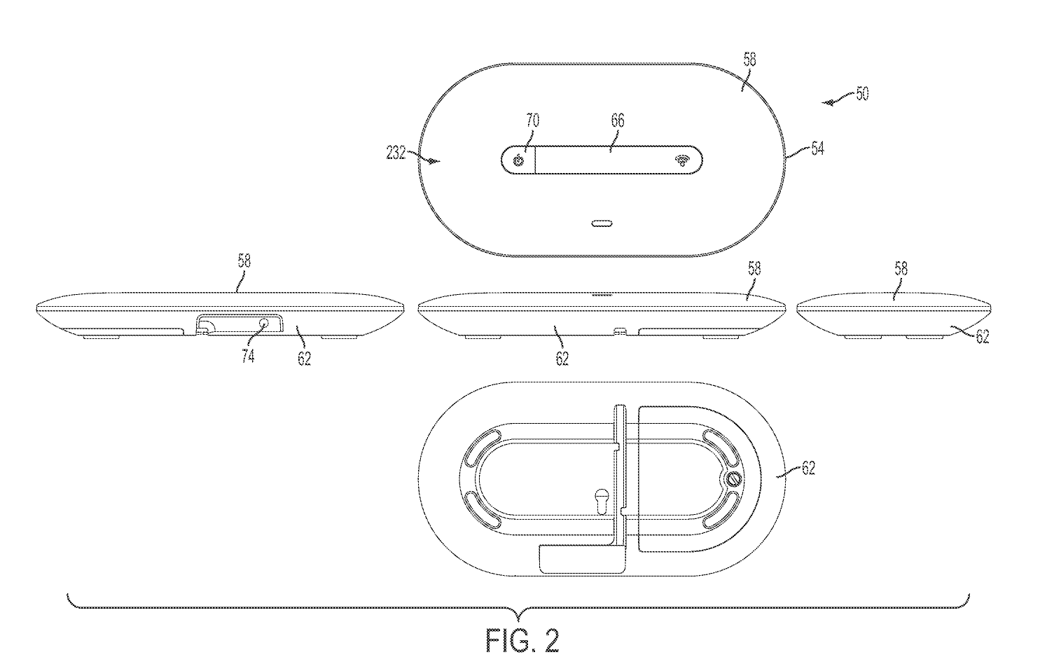

FIG. 2 illustrates a child unit 50 according to one embodiment of the present invention. The child unit 50 includes a housing 54 for supporting an electronics module (discussed below), a top panel 58, and a bottom panel 62. The top panel 58 includes a user interface panel 66 having an indicator for power. The top panel 58 includes an indicator for battery life. The user interface panel 66 and the top panel 58 can include other suitable indicators than the indicators illustrated. The user interface panel 66 also can include a screen for displaying video. The child unit 50 also can include a video camera supported by the housing for acquiring video of the child. The child unit 50 also includes a power activation button 70 coupled to the housing 54. The child unit 50 also can include a port 74 to connect to an external power source.

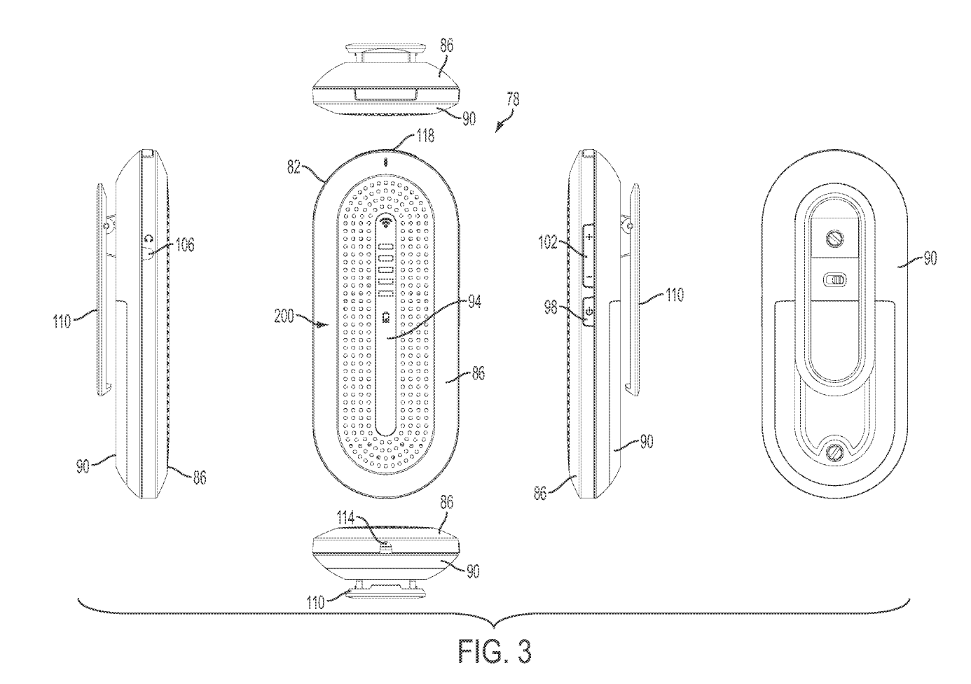

FIG. 3 illustrates a parent unit 78 according to another embodiment of the present invention. The parent unit 78 includes a housing 82 for supporting an electronics module (discussed below). The housing 82 includes a front panel 86 and a rear panel 90. The front panel 86 includes a user interface panel 94 having a plurality of indicators for a volume setting, battery life, and power. The user interface panel 94 can include other suitable indicators than the indicators illustrated. The parent unit 78 also includes a power activation button 98 coupled to the housing 82 and a volume setting activation button 102 coupled to the housing 82. The parent unit 78 also can include a port 106 in which to connect a head set. The parent unit 78 also can include a clip 110 coupled to the rear panel 90 that the parent can use to clip the unit to a belt or to another location and carry the unit while working or moving. The parent unit 78 also can include a port 114 to connect to an external power source. The parent unit 78 also can include a talk activation button 118 that when activated allows one parent unit 78 to communicate with a second parent unit 78. For example, the talk activation button 118 allows two parents or other users of the parent units 78 to talk and have a two-way conversation without the child hearing the conversation or being disturbed. The front panel 86 can include a symbol near the talk activation button 118 operable to illuminate when the talk activation button 118 is activated. The symbol on a second parent unit 78 can illuminate when it receives a signal from a first parent unit 78 when the first parent unit 78 is trying to communicate with the second parent unit 78.

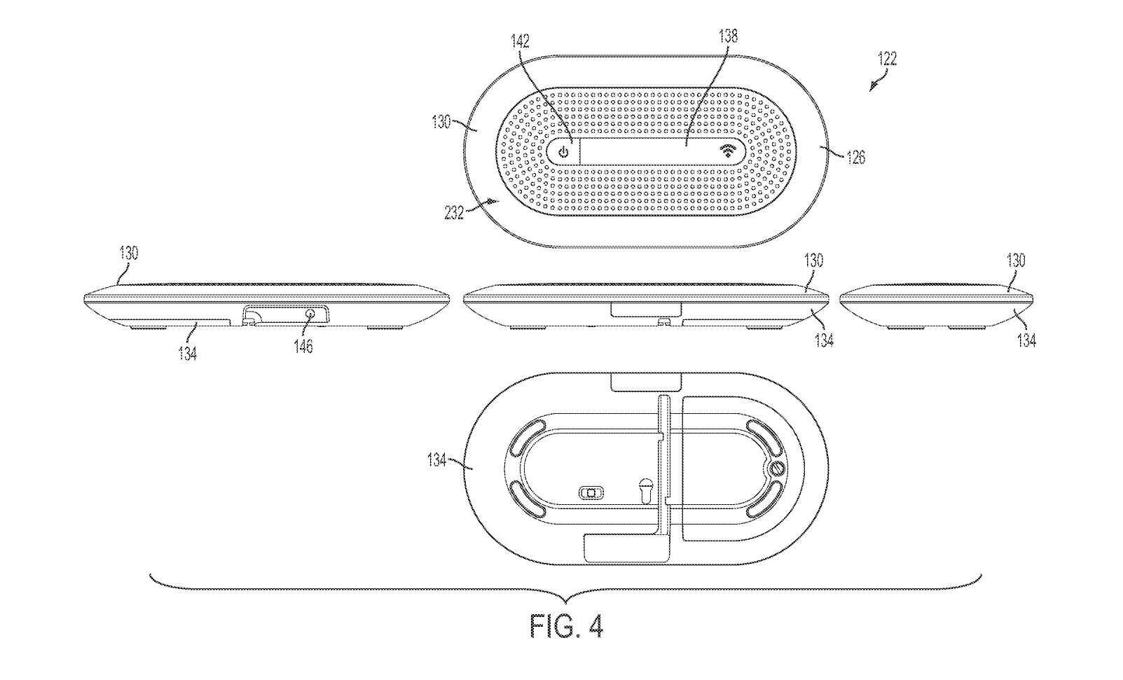

FIG. 4 illustrates a child unit 122 according to one embodiment of the present invention. The child unit 122 includes a housing 126 for supporting an electronics module (discussed below), a top panel 130, and a bottom panel 134. The top panel 130 includes a user interface panel 138 having an indicator for power. The user interface panel 138 and the top panel 130 can include other suitable indicators than the indicators illustrated. The child unit 122 also includes a power activation button 142 coupled to the housing 126. The child unit 122 also can include a port 146 to connect to an external power source.

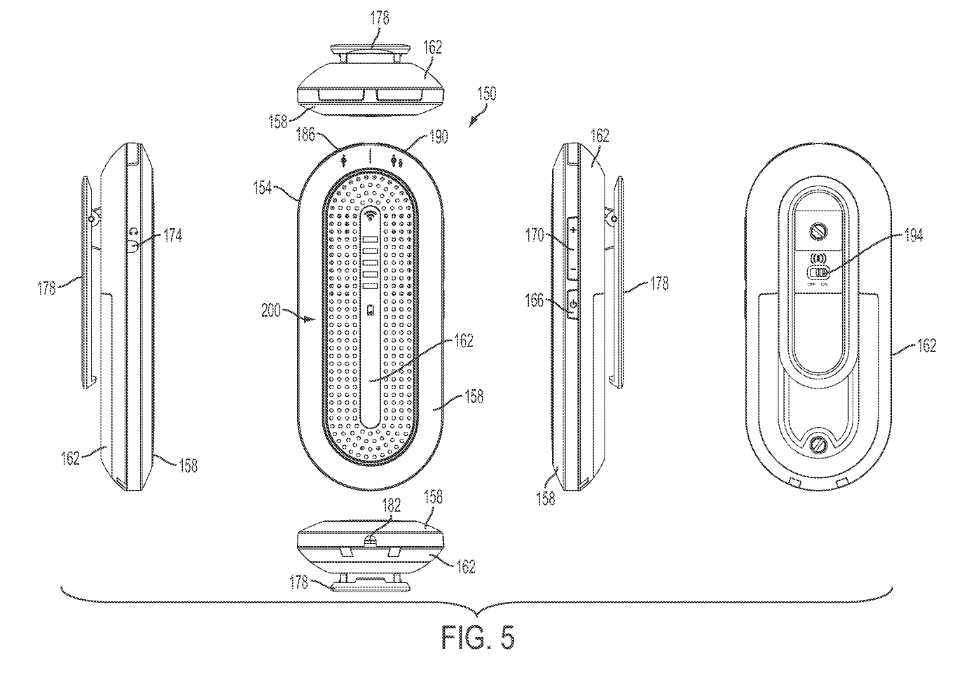

FIG. 5 illustrates a parent unit 150 according to another embodiment of the present invention. The parent unit 150 includes a housing 154 for supporting an electronics module (discussed below). The housing 154 includes a front panel 158 and a rear panel 162. The front panel 158 includes a user interface panel 162 having a plurality of indicators for a volume setting, battery life, and power. The user interface panel 162 can include other suitable indicators than the indicators illustrated. The parent unit 150 also includes a power activation button 166 coupled to the housing 154 and a volume setting activation button 170 coupled to the housing 154. The parent unit 150 also can include a port 174 in which to connect a head set. The parent unit 150 also can include a clip 178 coupled to the rear panel 162 that the parent can use to clip the unit to a belt or to another location and carry the unit while working or moving. The parent unit 150 also can include a port 182 to connect to an external power source. The parent unit 150 also can include a first talk activation button 186 that when activated allows one parent unit 150 to communicate with a second parent unit 150. For example, the first talk activation button 186 allows two parents or other users of the parent units 150 to talk and have a two-way conversation without the child hearing the conversation or being disturbed. The front panel 158 can include a symbol near the first talk activation button 186 operable to illuminate when the talk activation button 186 is activated. The symbol on a second parent unit 150 can illuminate when it receives a signal from a first parent unit 150 when the first parent unit 150 is trying to communicate with the second parent unit 150. The parent unit 150 also can include a second talk activation button 190 that when activated allows the parent unit 150 to communicate with a child unit 50 or 122. In addition, if the second talk activation button 190 is activated on a second parent unit 150, the first parent unit 150, the second parent unit 150, and the child unit 50 or 122 can communicate such that one or both parents can communicate with the child. The parent unit 150 also can include a vibration activation button 194 coupled to the rear panel 162 and operable to cause vibration when a RF signal is received from the child unit.

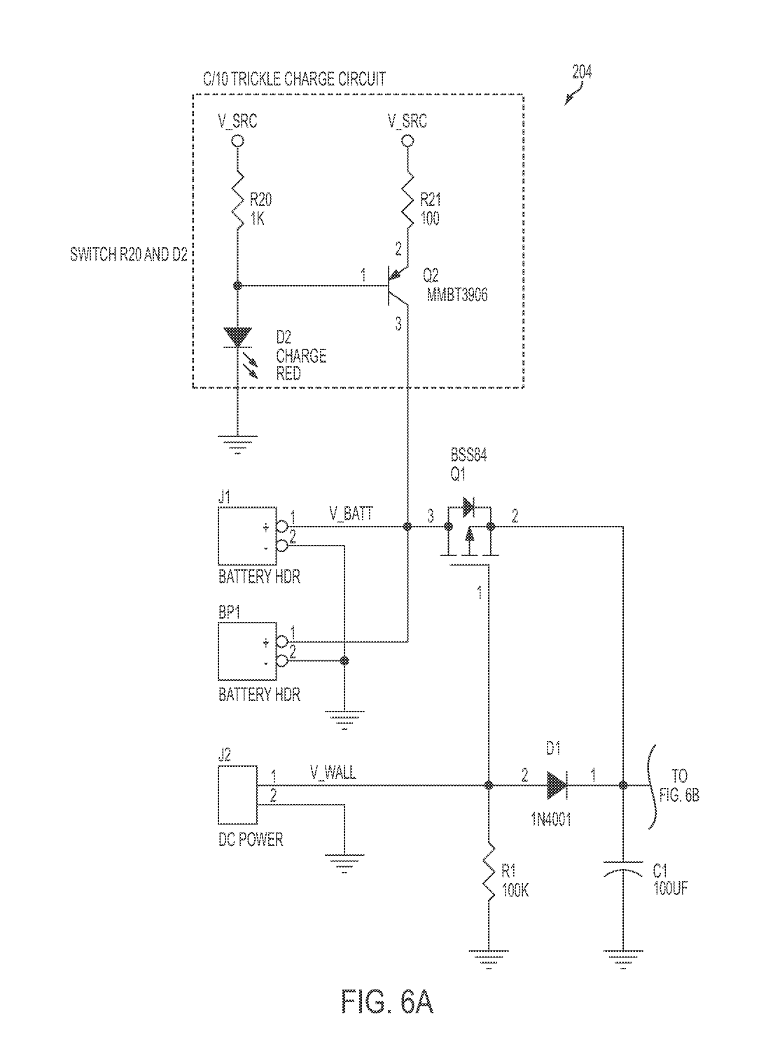

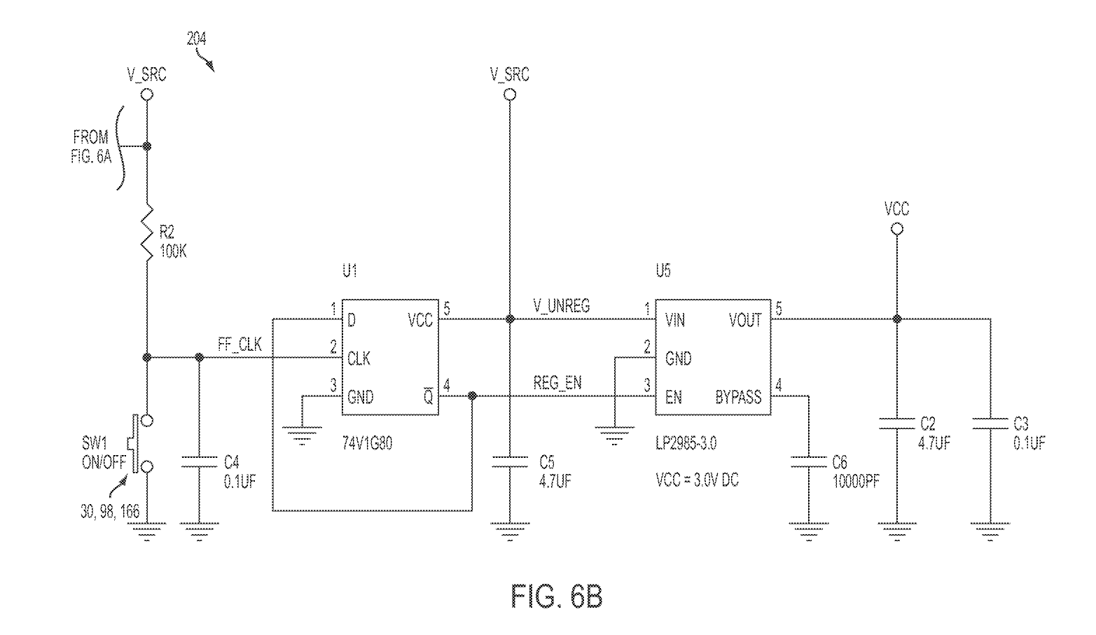

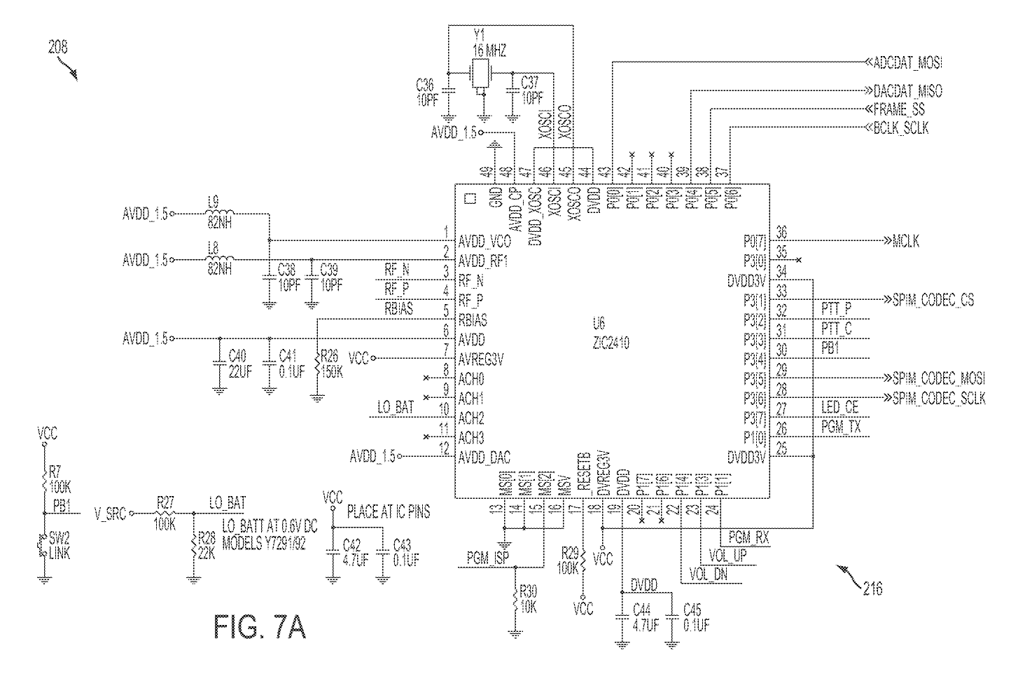

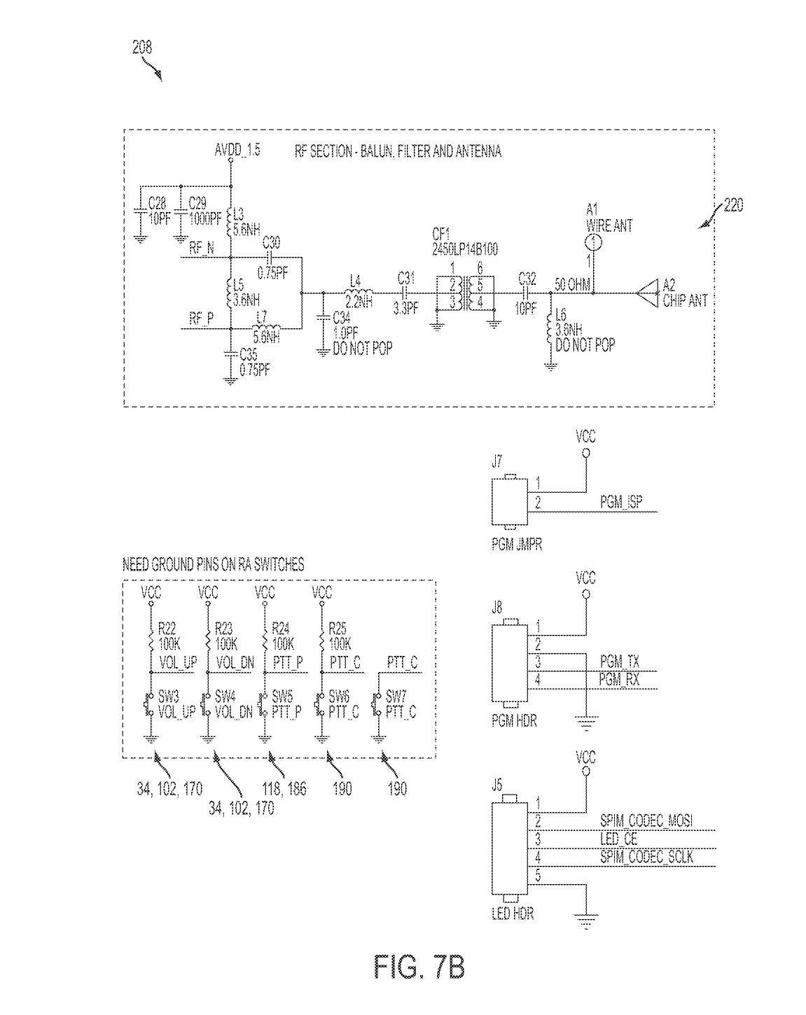

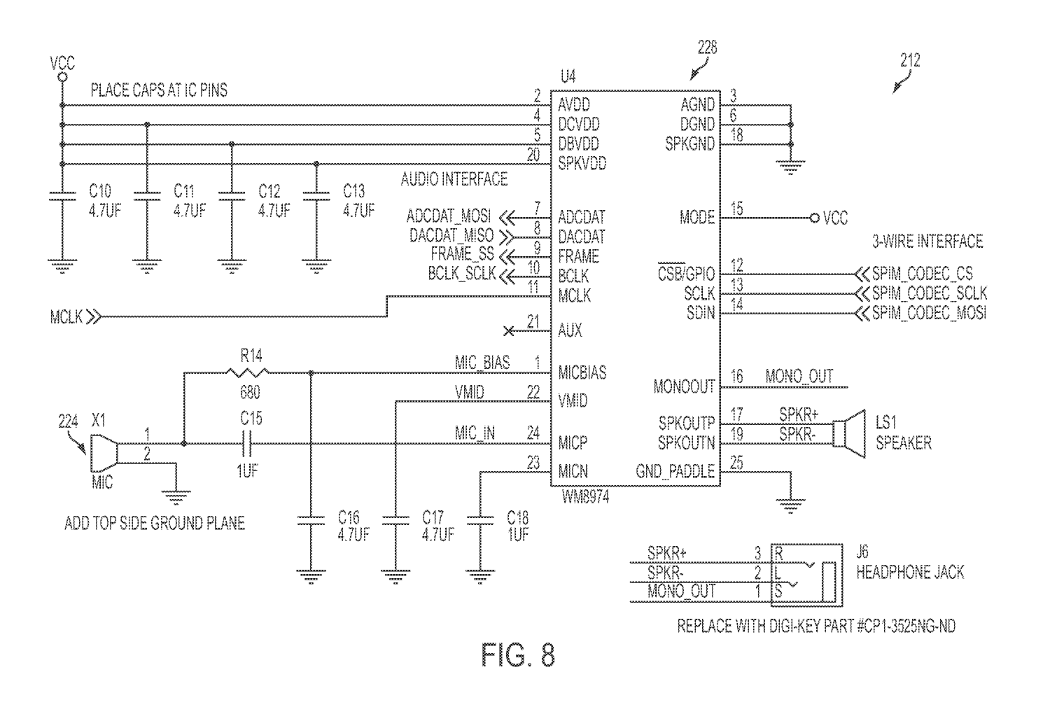

As mentioned above, the parent units 10, 78, and 150 include an electronics module 200. The parent units 10, 78, 150 can include the same electronics module 200, but with different features enabled. The electronics module 200 includes a power supply module 204 as illustrated in FIGS. 6A and 6B, a communications module 208 as illustrated in FIGS. 7A and 7B, and a CODEC module 212 as illustrated in FIG. 8.

The power supply module 204 processes the incoming power whether from a battery or an AC power source such as household power when the power activation button 30, 98, 166 on the parent unit 10, 78, 150 is activated. The power supply module 204 provides power to the communications module 208 and the CODEC module 212.

The communications module 208 includes a controller 216 (such as a ZIC2410 available from California Eastern Laboratories; the datasheet of the ZIC2410 is incorporated herein by reference) compliant with ZigBee specifications and applications and an antenna 220 operable to receive a RF signal from multiple, individual units (e.g., the child unit or another parent unit) and to transmit a RF signal to select units (e.g., the child unit or another parent unit). The controller 216 includes a transceiver operable to receive a RF signal, process the RF signal (in conjunction with the CODEC module 212), and provide an acoustical audio output signal representative of the sounds generated by the baby or the parent (or user of the parent unit). The transceiver is also operable to transmit a RF signal.

The CODEC module 212 includes a microphone 224 operable to detect acoustical audio signals generated by the parent (or user of the parent unit). The CODEC module 212 also includes a coder/decoder microchip 228 (such as WM8974 available from Wolfson Microelectronics; the datasheet of the WM8974 is incorporated herein by reference) operable to receive the RF signal from the transceiver and convert the RF signal, using an audio decoder, to an acoustical audio output signal representative of the sounds generated by the baby. The coder/decoder microchip 228 also is operable to receive an acoustical audio signals detected by the microphone 224 and to convert the analog acoustical audio signals into RF digital signals for transmission or storage.

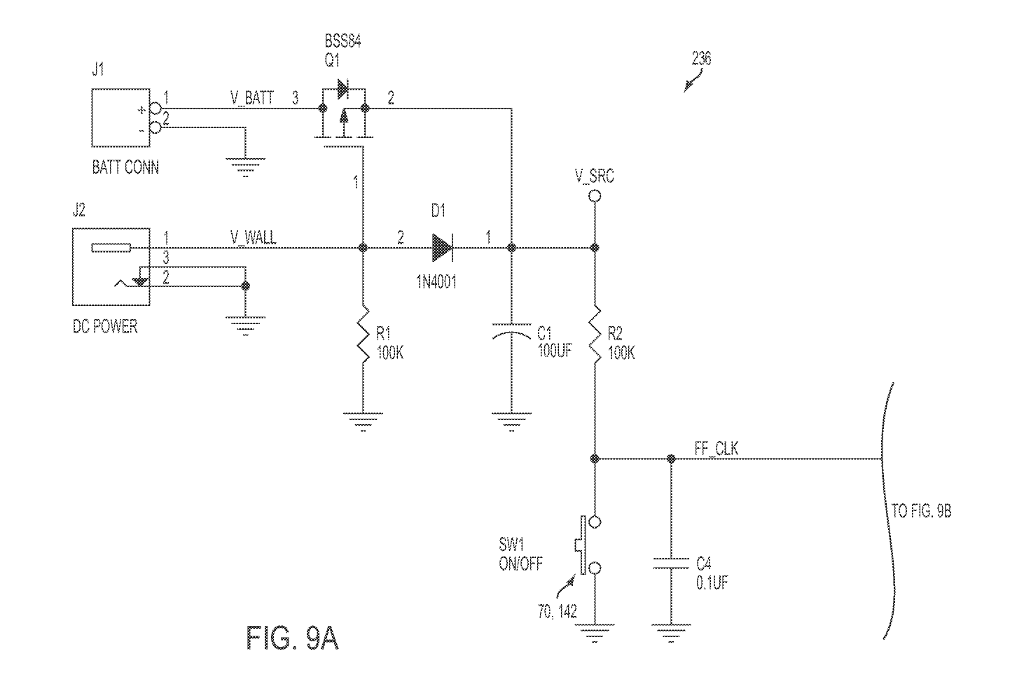

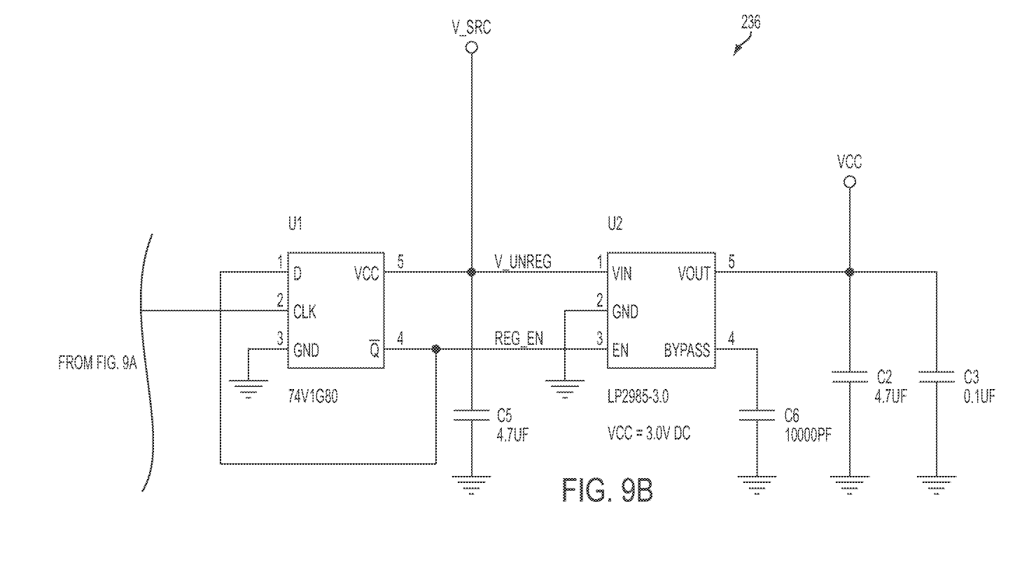

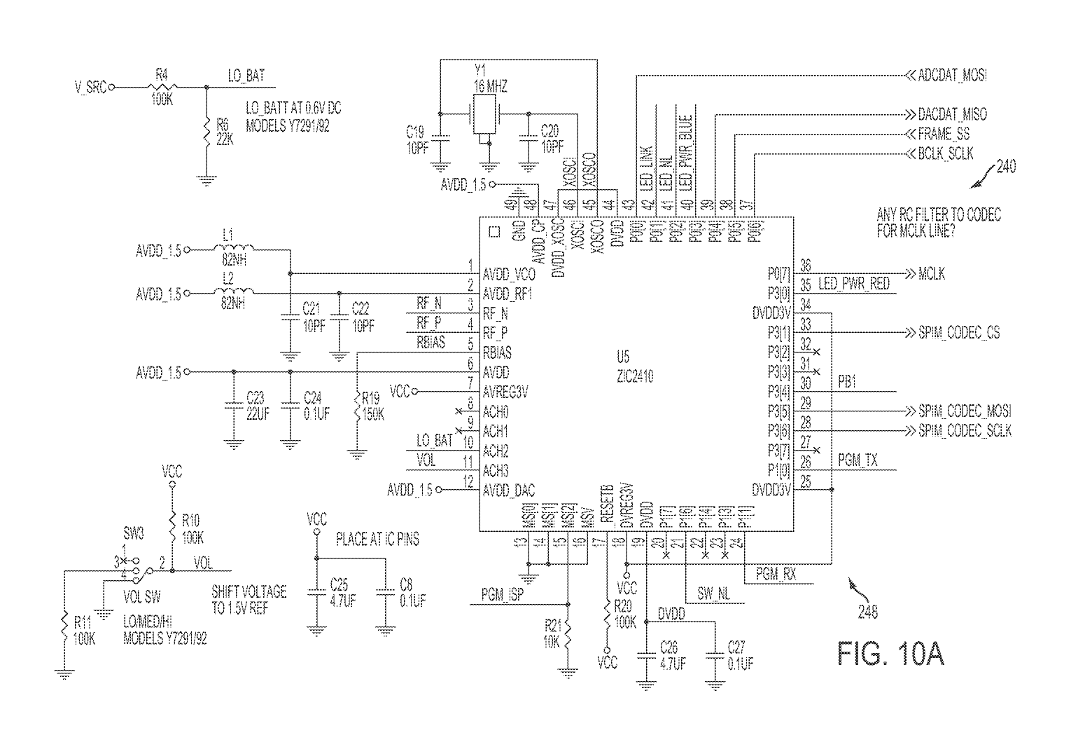

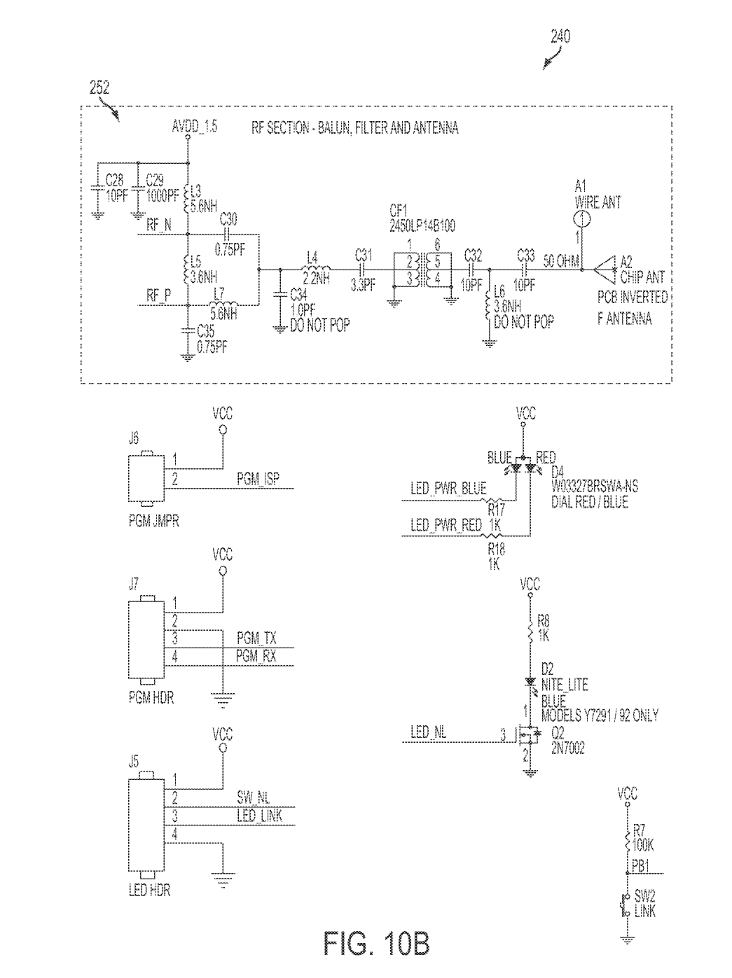

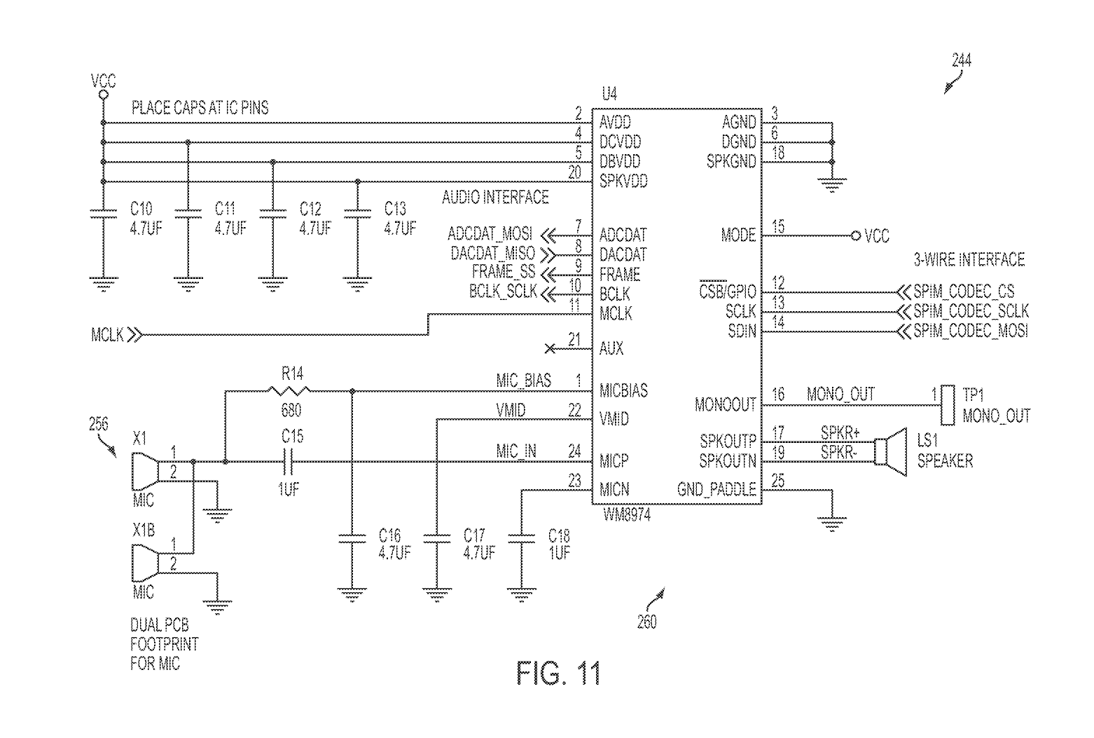

As mentioned above, the child units 50 and 122 include an electronics module 232. The child units 50, 122 can include the same electronics module 232, but with different features enabled. The electronics module 232 includes a power supply module 236 as illustrated in FIGS. 9A and 9B, a communications module 240 as illustrated in FIGS. 10A and 10B, and a CODEC module 244 as illustrated in FIG. 11.

The power supply module 236 processes the incoming power whether from a battery or an AC power source such as household power when the power activation button 70, 142 on the child unit 50, 122 is activated. The power supply module 236 provides power to the communications module 240 and the CODEC module 244.

The communications module 240 includes a controller 248 (such as a ZIC2410 available from California Eastern Laboratories) compliant with ZigBee specifications and applications and an antenna 252 operable to receive a RF signal from the parent unit and to transmit a RF signal to the parent unit. The controller 248 includes a transceiver operable to receive a RF signal from a parent unit, process the RF signal (in conjunction with the CODEC module 244), and provide an acoustical audio output signal representative of the sounds generated by the parent (or user of the parent unit). The transceiver is also operable to transmit a RF signal representative of the sounds generated by the baby.

The CODEC module 244 includes a microphone 256 operable to detect acoustical audio signals generated by the baby or the parent (if the parent is near the child unit). The CODEC module 244 also includes a coder/decoder microchip 260 (such as WM8974 available from Wolfson Microelectronics) operable to receive the acoustical audio signals detected by the microphone 256. The coder/decoder microchip 260, using an audio coder, is operable to convert the analog acoustical audio signals into digital RF signals for transmission or storage. The coder/decoder microchip 260 also is operable to receive a RF signal from a parent unit and convert the RF signal, using an audio decoder, to an acoustical audio output signal representative of the sounds generated by the parent.

In a standard operation mode, a child unit is positioned in an area where a baby is to be monitored and a parent unit is positioned with a parent or other user. The microphone 256 on the child unit detects an acoustic signal generated by the baby and the coder/decoder microchip 260 converts the acoustic signal into a digital RF signal for transmission by the controller 248. The parent unit receives the digital RF signal. The coder/decoder microchip 228 decodes the digital RF signal to convert the RF signal back into an analog signal representative of the sounds generated by the baby. The controller 216 outputs the analog signal to be heard by the parent.

In a first enhanced operation mode, a child unit is positioned in an area where a baby is to be monitored and a parent unit is positioned with a parent or other user. The microphone 256 on the child unit detects an acoustic signal generated by the baby and the coder/decoder microchip 260 converts the acoustic signal into a digital RF signal for transmission by the controller 248. The parent unit receives the digital RF signal. The coder/decoder microchip 228 decodes the digital RF signal to convert the RF signal back into an analog signal representative of the sounds generated by the baby. The controller 216 outputs the analog signal to be heard by the parent.

Additionally, in the first enhanced operation mode, a first parent unit can communicate with a second parent unit. In this scenario, the microphone 224 detects acoustic signals generated by one parent and the coder/decoder microchip 228 converts the acoustic signal into a digital RF signal for transmission by the controller 216. The second parent unit receives the digital RF signal from the first parent unit. The coder/decoder microchip 228 decodes the digital RF signal to convert the RF signal back into an analog signal representative of the sounds generated by the parent. The controller 216 outputs the analog signal to the heard by the parent holding the second parent unit. Two-way communication can continue between the parents via the parent units.

In a second enhanced operation mode, a child unit is positioned in an area where a baby is to be monitored and a parent unit is positioned with a parent or other user. The microphone 256 on the child unit detects an acoustic signal generated by the baby and the coder/decoder microchip 260 converts the acoustic signal into a digital RF signal for transmission by the controller 248. The parent unit receives the digital RF signal. The coder/decoder microchip 228 decodes the digital RF signal to convert the RF signal back into an analog signal representative of the sounds generated by the baby. The controller 216 outputs the analog signal to be heard by the parent.

Additionally, in the second enhanced operation mode, a first parent unit can communicate with a second parent unit. In this scenario, the microphone 224 detects acoustic signals generated by one parent and the coder/decoder microchip 228 converts the acoustic signal into a digital RF signal for transmission by the controller 216. The second parent unit receives the digital RF signal from the first parent unit. The coder/decoder microchip 228 decodes the digital RF signal to convert the RF signal back into an analog signal representative of the sounds generated by the parent. The controller 216 outputs the analog signal to be heard by the parent holding the second parent unit. Two-way communication can continue between the parents via the parent units.

Furthermore, in the second enhanced operation mode, a first and/or a second parent unit can communicate with the child unit to provide for three-way communication between one or more parents and the baby or a parent in the vicinity of the child unit. In this scenario, the microphone 224 detects acoustic signals generated by one or more of the parents and the coder/decoder microchip 228 converts the acoustic signal into a digital RF signal for transmission by the controller 216. The child unit receives the digital RF signal from the first parent unit. At the child unit, the coder/decoder microchip 260 decodes the digital RF signal to convert the RF signal back into an analog signal representative of the sounds generated by the parent. The controller 248 outputs the analog signal to be heard by the child and/or a parent in the vicinity of the child unit. Similarly, the second parent unit can also receive the digital RF signal from the first parent unit. The coder/decoder microchip 228 decodes the digital RF signal to convert the RF signal back into an analog signal representative of the sounds generated by the parent. The controller 216 outputs the analog signal to be heard by the parent holding the second parent unit.

Various features and advantages of the invention are set forth in the following claims.

What is claimed is:

1. A baby monitor comprising:
a receiver configured to receive a plurality of digital signals, each produced by a separate electrical unit;
a speaker configured to output sound waves represented by the plurality of digital signals;
a microphone configured to detect sound waves generated by a first user;
a CODEC configured to convert the sound waves generated by the first user to a digital signal; and
a transmitter operable in a first mode, in which the transmitter transmits the digital signal representative of the sound waves generated by the first user to at least one of the electrical units from which the receiver has received a digital signal, and is operable in a second mode, in which the transmitter transmits the digital signal representative of the sound waves generated by the first user to a different one of the electrical units from which the receiver has received a digital signal.

2. The baby monitor of claim 1, wherein the plurality of digital signals received by the receiver includes a first digital signal representative of sound waves generated by a second user and a second digital signal representative of sound waves generated by a third user.

3. The baby monitor of claim 2, wherein the first digital signal is transmitted by a first device and the second digital signal is transmitted by a second device, and wherein during the first mode of operation, the transmitter transmits the digital signal representative of the sound waves generated by the first user to the second device.

4. The baby monitor of claim 3, wherein during the second mode of operation, the transmitter transmits the digital signal representative of the sound waves generated by the first user to the first device.

5. The baby monitor of claim 3, wherein the first device includes a microphone configured to detect sound waves generated by the second user, a CODEC configured to convert the sound waves to a digital signal, and a transmitter configured to transmit the digital signal representative of the sound waves generated by the second user.

6. The baby monitor of claim 3, wherein the second device includes a receiver configured to receive the digital signal representative of the sound waves generated by the second user and the digital signal representative of the sound waves generated by the first user.

7. The baby monitor of claim 1, wherein the transmitter is operable in the first mode when a first talk activation button is depressed and the transmitter is operable in the second mode when a second talk activation button is depressed.

8. The baby monitor of claim 1, wherein the transmitter is operable in a third mode in which no signal is transmitted.

9. The baby monitor of claim 1, wherein the speaker outputs the sounds represented in each of the received digital signals simultaneously.

10. The baby monitor of claim 1, wherein the transmitter is operable in a third mode, in which the transmitter transmits the digital signal representative of the sound waves generated by the first user to all the electrical units from which it has received a digital signal.

11. A baby monitor comprising:
a receiver configured to receive a first digital signal produced by a first unit representative of sound waves generated by a first user, and a second digital signal produced by a second unit representative of sound waves generated by a second user;
a speaker configured to output the sounds generated by the first user during the output of the sounds generated by the second user;
a microphone configured to detect sound waves generated by a third user;
a CODEC configured to convert the sound waves generated by the third user to a digital signal; and
a transmitter operable in a first mode, in which the transmitter transmits the digital signal representative of the sound waves generated by the third user to one of the first unit and the second unit, and operable in a second mode, in which the transmitter transmits the digital signal representative of the sound waves generated by the third user to both the first unit and the second unit.

12. The baby monitor of claim 11, wherein the first unit includes a microphone configured to detect sound waves generated by the first user, a CODEC configured to convert the sound waves to a digital signal, and a transmitter configured to transmit the digital signal representative of the sound waves generated by the first user.

13. The baby monitor of claim 11, wherein the second unit includes a receiver configured to receive the digital signal representative of the sound waves generated by the first user, a speaker configured to output the sounds generated by the first user as represented in the digital signal, a microphone configured to detect sound waves generated by a second user, a CODEC configured to convert the sound waves generated by the second user to a digital signal, and a transmitter configured to transmit the digital signal representative of the sound waves generated by the second user.

14. The baby monitor of claim 13, wherein the receiver of the second unit is further configured to receive the digital signal representative of the sound waves generated by the third user and the speaker of the second unit is further configured to output the sounds generated by the third user as represented in the digital signal.

15. The baby monitor of claim 11, wherein the transmitter is operable in the first mode when a first talk activation button is depressed and the transmitter is operable in the second mode when a second talk activation button is depressed.

16. The baby monitor of claim 11, wherein the transmitter is operable in a third mode in which no digital signal is transmitted.

17. The baby monitor of claim 11, wherein the speaker is configured to output the sounds generated by the first user and the sounds generated by the second user, simultaneously.

18. A baby monitor comprising:
a first unit including:
a microphone configured to detect sound waves generated by first user,
a CODEC configured to convert the sound waves to a digital signal, and
a transmitter configured to transmit the digital signal representative of the sound waves generated by the first user;
a second unit including:
a receiver configured to receive the digital signal representative of the sound waves generated by the first user,
a speaker configured to output the sounds generated by the first user as represented in the digital signal,
a microphone configured to detect sound waves generated by a second user,
a CODEC configured to convert the sound waves generated by the first adult to a digital signal, and
a transmitter configured to transmit the digital signal representative of the sound waves generated by the second user;
a third unit including:
a receiver configured to receive the digital signal representative of the sound waves generated by the first user,
a speaker configured to output the sounds generated by the first user as represented in the digital signal,
a microphone configured to detect sound waves generated by a third user,
a CODEC configured to convert the sound waves generated by the third user to a digital signal, and
a transmitter configured to transmit the digital signal representative of the sound waves generated by the third user;
wherein the receiver of the second unit is further configured to receive the digital signal representative of the sound waves generated by the third user and the speaker of the second unit is further configured to output the sounds generated by the third user as represented in the digital signal,
wherein the receiver of the third unit is further configured to receive the digital signal representative of the sound waves generated by the second user and the speaker of the third unit is further configured to output the sounds generated by the second user as represented in the digital signal, such that the second unit outputs the sounds generated by the first user during the output of the sounds generated by the third user.

19. The baby monitor of claim 18, wherein the first unit includes a receiver configured to receive at least one of the digital signal representative of the sound waves generated by the second user and the digital signal representative of the sound waves generated by the third user.

20. The baby monitor of claim 18, wherein the speaker of the third unit is operable to output the sounds generated by the second user and the sounds generated by the first user, simultaneously.
